(19) United States
(12) Patent Application Publication
(10) Pub. No.: US 2025/0061912 A1
(43) Pub. Date: Feb. 20, 2025

(54) INFORMATION PROCESSING DEVICE, NON-TRANSITORY COMPUTER-READABLE STORAGE MEDIUM, AND INFORMATION PROCESSING METHOD

(71) Applicant: MITSUBISHI ELECTRIC CORPORATION, Tokyo (JP)

(72) Inventor: Ryo AIHARA, Tokyo (JP)

(73) Assignee: MITSUBISHI ELECTRIC CORPORATION, Tokyo (JP)

(21) Appl. No.: 18/940,000

(22) Filed: Nov. 7, 2024

Related U.S. Application Data
(63) Continuation of application No. PCT/JP2022/020921, filed on May 20, 2022.

(51) Int. Cl. G10L 21/0224; G06F 3/16; G10L 21/0264

(52) U.S. Cl. CPC G10L 21/0224; G06F 3/162; G10L 21/0264

(57) ABSTRACT

A speech enhancement device that calculates an acoustic component from mixed audio data; that estimates an acoustic feature by inputting the acoustic component to a feature estimation model; that calculates a noise component from noise data; that estimates a noise feature by inputting the noise component to a noise estimation model; that estimates a correlation between the acoustic feature and the noise feature by inputting the acoustic feature and the noise feature to a correlation estimation model; that calculates an integrated feature by weighting the acoustic feature with the estimated correlation; that estimates a target speech mask by inputting the integrated feature to a speech enhancement model; and that restores speech audio with the target speech audio enhanced from the acoustic component and the target speech mask.

### CROSS REFERENCE TO RELATED APPLICATION

This application is a continuation application of International Application No. PCT/JP2022/020921 having an international filing date of May 20, 2022, which is hereby expressly incorporated by reference into the present application.

### BACKGROUND OF THE INVENTION

### 1. Field of the Invention

The disclosure relates to an information processing device, a non-transitory computer-readable storage medium, and an information processing method.

### 2. Description of the Related Art

Conventionally, speech recognition processing has been performed to recognize speech. In general, speech recognition processing is affected by noise other than the target speech audio, and when noise is present, the accuracy of speech recognition is significantly reduced. Therefore, it is necessary to extract the target speech audio from noisy audio.

For example, NPL 1 proposes a method of using neural networks (NNs) to learn pair data of mixed audio and target speech audio and extract the target speech audio from the mixed audio.

Non-Patent Literature: Felix Weninger, et al., “Discriminatively trained recurrent neural networks for single-channel speech separation,” IEEE Global Conference on Signal and Information Processing (GlobalSIP), February 2015.

### SUMMARY OF THE INVENTION

However, the conventional method of learning sounds that are a mixture of speech and non-speech has a problem in that speech enhancement performance decreases for unlearned non-speech.

Accordingly, an object of one or more aspects of the disclosure is to enhance speech even with unknown noise that is not included in training data.

An information processing device according to an aspect of the disclosure includes: processing circuitry to calculate an acoustic component from mixed audio data by using a predetermined function, the mixed audio data including target speech audio and mixed noise, the target speech audio being a target to be enhanced, the mixed noise being noise to be mixed with the target speech audio, the acoustic component being a component of the target speech audio and the mixed noise; to estimate an acoustic feature by inputting the acoustic component to a feature estimation model trained to estimate an acoustic feature of speech and noise; a noise-component calculating unit configured to calculate a noise component from noise data by using the predetermined function, the noise component being a component of noise, the noise data not including the target speech audio and including noise; to estimate a noise feature by inputting the noise component to a noise estimation model trained to estimate an acoustic feature of the noise; to estimate a correlation between the acoustic feature and the noise feature by inputting the acoustic feature and the noise feature to a correlation estimation model trained to estimate a correlation between the acoustic feature of speech and noise, and the acoustic feature of noise; to calculate an integrated feature by weighting the acoustic feature with the estimated correlation; to estimate a target speech mask by inputting the integrated feature to a speech enhancement model trained to estimate a mask for enhancing speech; and to restore speech audio in which the target speech audio is enhanced from the acoustic component and the target speech mask.

According to one or more aspects of the disclosure, speech can be enhanced even with unknown noise that is not included in training data.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a block diagram schematically illustrating a configuration of a speech enhancement system according to first to fourth embodiments;

FIG. 2 is a block diagram schematically illustrating a configuration of a training device according to the first embodiment;

FIGS. 3A and 3B are block diagrams illustrating hardware configuration examples;

FIG. 4 is a block diagram schematically illustrating a configuration of a speech enhancement device according to the first embodiment;

FIG. 5 is a flowchart illustrating the operation of the training device according to the first embodiment;

FIG. 6 is a flowchart illustrating the operation of the speech enhancement device according to the first embodiment;

FIG. 7 is a block diagram schematically illustrating a configuration of a speech enhancement device according to the second embodiment;

FIG. 8 is a flowchart illustrating the operation of the speech enhancement device according to the second embodiment;

FIG. 9 is a block diagram schematically illustrating a configuration of a training device according to the third embodiment;

FIG. 10 is a block diagram schematically illustrating a configuration of the speech enhancement device according to the third embodiment;

FIG. 11 is a flowchart illustrating the operation of the training device according to the first embodiment;

FIG. 12 is a flowchart illustrating the operation of the speech enhancement device according to the third embodiment;

FIG. 13 is a block diagram schematically illustrating a configuration of a speech enhancement device according to the fourth embodiment; and

FIG. 14 is a flowchart illustrating the operation of the speech enhancement device according to the fourth embodiment.

### DETAILED DESCRIPTION OF THE INVENTION

### First Embodiment

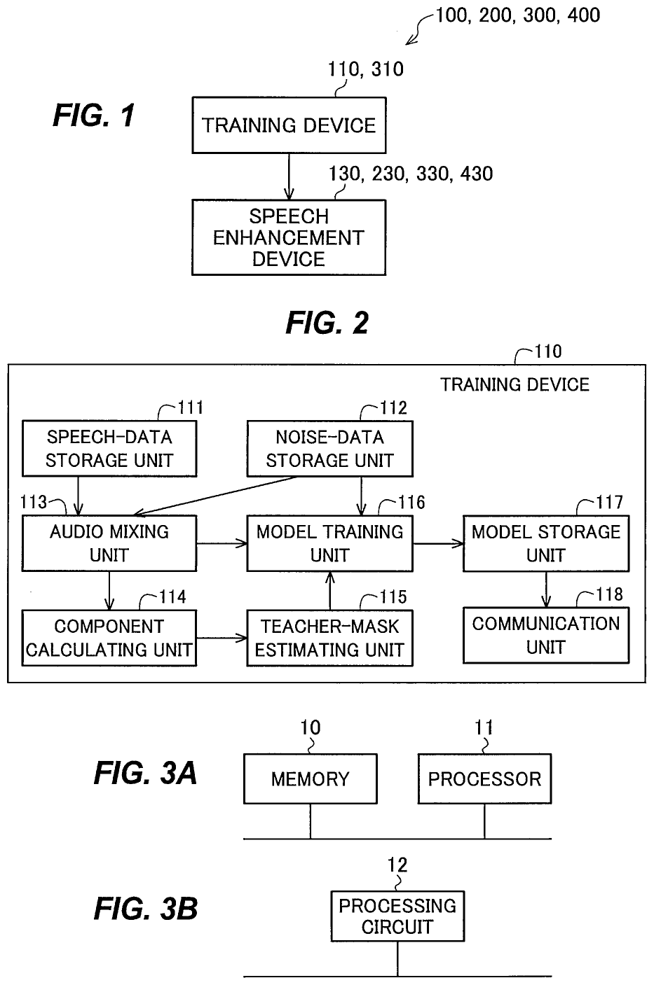

FIG. 1 is a block diagram schematically illustrating a configuration of a speech enhancement system 100 according to the first embodiment.

The speech enhancement system 100 includes a training device 110 and a speech enhancement device 130 serving as an information processing device.

The training device 110 trains learning models that function as a feature estimation NN, which is a feature estimation model for estimating an acoustical feature of speech and noise, a noise estimation NN, which is a noise estimation model for estimating an acoustical feature of noise, a correlation estimation NN, which is a correlation estimation model for estimating a correlation between the acoustical feature of speech and noise and the acoustical feature of noise, and a speech enhancement NN, which is a speech enhancement model for estimating a mask for enhancing speech.

The speech enhancement device 130 acquires the trained feature estimation NN, noise estimation NN, correlation estimation NN, and speech enhancement NN from the training device 110 and uses these learning models to enhance target speech audio in mixed audio.

In a training phase, the training device 110 trains the learning models to be used by the speech enhancement device 130.

In an inference phase, the speech enhancement device 130 uses the learning models trained by the training device to enhance the target speech audio in the mixed audio.

FIG. 2 is a block diagram schematically illustrating a configuration of the training device 110 according to the first embodiment.

The training device 110 includes a speech-data storage unit 111, a noise-data storage unit 112, an audio mixing unit 113, a component calculating unit 114, a teacher-mask estimating unit 115, a model training unit 116, a model storage unit 117, and a communication unit 118.

The speech-data storage unit 111 stores training-purpose speech data, which represents training-purpose target speech audio to be used for training.

The noise-data storage unit 112 stores training-purpose noise data, which represents training-purpose noise to be used for training.

The audio mixing unit 113 acquires the training-purpose speech data from the speech-data storage unit 111 and the training-purpose noise data from the noise-data storage unit 112, selects the training-purpose target speech audio represented by the training-purpose speech data and the training-purpose noise represented by the training-purpose noise data, superimposes these to generate mixed audio, and gives the target speech audio and the mixed audio to the component calculating unit 114.

The component calculating unit 114 calculates a target speech component that is a component of the target speech audio from the audio mixing unit 113 and calculates a mixed audio component that is a component of the mixed audio from the audio mixing unit 113. For example, the component calculating unit 114 determines an audio component to be a time series of a power spectrum calculated from an audio signal by short-time Fourier transform (STFT). The target speech component and the mixed audio component are given to the teacher-mask estimating unit 115.

The teacher-mask estimating unit 115 generates a teacher mask from the target speech component and the mixed audio component from the component calculating unit 114. For example, the power spectrum of the target speech audio and the power spectrum of the mixed audio are estimated from the target speech component and the mixed audio component, respectively, and the ratio of the power spectrum of the target speech audio to the power spectrum of the mixed audio is determined to a teacher mask. The teacher mask is given to the model training unit 116.

The model training unit 116 receives the mixed audio from the audio mixing unit 113, the training-purpose noise data from the noise-data storage unit 112, and the teacher mask from the teacher-mask estimating unit 115, and trains the NNs. The training of an NN is a process of determining an input weight coefficient, which is a parameter of the NN. During training, the feature estimation NN, the noise estimation NN, the correlation estimation NN, and the speech enhancement NN are combined and input to, for example, a loss function mentioned in the following reference, and an error is calculated on the basis of the training-purpose target speech audio. Then, for example, an optimization method such as adaptive moment estimation (Adam) may be used to learn the input weight coefficient of each layer of the feature estimation NN, noise estimation NN, correlation estimation NN, and speech enhancement NN on the basis of, for example, the backpropagation. The generated feature estimation NN, noise estimation NN, correlation estimation NN, and speech enhancement NN are stored in the model storage unit 117.

Reference: R. Aihara et al., “Deep clustering-based single-channel speech separation and recent advances,” Acoust. Sci. & Tech. 41. 2. 2020.

The model storage unit 117 stores the feature estimation NN, the noise estimation NN, the correlation estimation NN, and the speech enhancement NN trained by the model training unit 116.

The communication unit 118 functions as a transmitting unit that transmits the feature estimation NN, the noise estimation NN, the correlation estimation NN, and the speech enhancement NN stored in the model storage unit 117 to the speech enhancement device 130.

Some or all of the audio mixing unit 113, the component calculating 114, unit the teacher-mask estimating unit 115, and the model training unit 116 described above can be implemented by, for example, a memory 10 and a processor 11 such as a central processing unit (CPU) that executes programs stored in the memory 10, as illustrated in FIG. 3A. In other words, the training device can be implemented by what is commonly known as a computer. Such programs may be provided over a network or may be recorded and provided on a recording medium. That is, such programs may be provided, for example, as a program product.

Some or all of the audio mixing unit 113, the component calculating unit 114, the teacher-mask estimating unit 115, and the model training unit 116 can also be implemented by, for example, a single circuit, a composite circuit, a processor ran by a program, a parallel processor ran by a program, a processing circuit 12 such as an application specific integrated circuit (ASIC) or a field programmable gate array (FPGA), as illustrated in FIG. 3B.

As described above, the audio mixing unit 113, the component calculating 114, unit the teacher-mask estimating unit 115, and the model training unit 116 can be implemented by processing circuitry.

The speech-data storage unit 111, the noise-data storage unit 112, and the model storage unit 117 can be implemented by storage (not illustrated) such as a hard disk drive (HDD), a solid-state drive (SSD), or a non-volatile memory.

The communication unit 118 can be implemented by a communication interface such a network interface card (NIC) or the like.

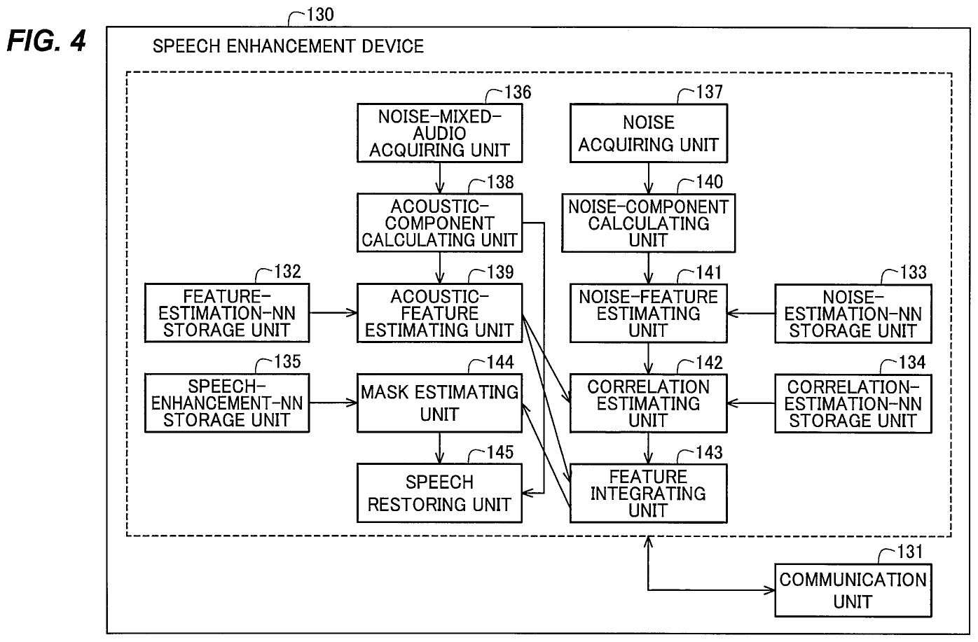

FIG. 4 is a block diagram schematically illustrating a configuration of the speech enhancement device 130 according to the first embodiment.

The speech enhancement device 130 includes a communication unit 131, a feature-estimation-NN storage unit 132, a noise-estimation-NN storage unit 133, a correlation-estimation-NN storage unit 134, a speech-enhancement-NN storage unit 135, a noise-mixed-audio acquiring unit 136, a noise acquiring unit 137, an acoustic-component calculating unit 138, an acoustic-feature estimating unit 139, a noise-component calculating unit 140, a noise-feature estimating unit 141, a correlation estimating unit 142, a feature integrating unit 143, a mask estimating unit 144, and a speech restoring unit 145.

The communication unit 131 functions as a receiving unit that receives the feature estimation NN, the noise estimation NN, the correlation estimation NN, and the speech enhancement NN from the training device 110.

The feature-estimation-NN storage unit 132 stores the feature estimation NN received by the communication unit 131.

The noise-estimation-NN storage unit 133 stores the noise estimation NN received by the communication unit 131.

The correlation-estimation-NN storage unit 134 stores the correlation estimation NN received by the communication unit 131.

The speech-enhancement-NN storage unit 135 stores the speech enhancement NN received by the communication unit 131.

The noise-mixed-audio acquiring unit 136 acquires mixed audio data representing mixed audio containing target speech audio and noise that has been collected with a microphone (not illustrated) functioning as a sound collecting unit. The noise contained in the mixed audio data is also referred to as mixed noise. For example, the noise-mixed-audio acquiring unit 136 may acquire mixed audio data via the communication unit 131 or may acquire mixed audio data from a microphone connected to a connection interface, such as a universal serial bus (USB). The mixed audio data here is also referred to as inference-purpose mixed audio data, and the mixed audio represented by the inference-purpose mixed audio data is also referred to as inference-purpose mixed audio. The communication unit 131 or the connection interface functions as an interface (input interface) that accepts input of data or an interface unit (input interface unit).

The noise acquiring unit 137 acquires noise data that represents noise collected with a microphone and that does not include target speech audio. For example, the noise-mixed-audio acquiring unit 136 may acquire noise data via the communication unit 131 or may acquire noise data from a microphone connected to the connection interface. Here, the noise can be, for example, sound collected at a certain time before or after the input of mixed audio containing target speech audio and noise to a microphone. The noise data here is also referred to as inference-purpose noise data, and the noise represented by the inference-purpose noise data is also referred to as inference-purpose noise.

The acoustic-component calculating unit 138 calculates an acoustic component from mixed audio data containing target speech audio, which is a target to be enhanced, and mixed noise, which is noise to be mixed with the target speech audio, by using a predetermined function.

For example, the acoustic-component calculating unit 138 receives the inference-purpose mixed audio data from the noise-mixed-audio acquiring unit 136 and calculates an acoustic component from the mixed audio represented by the inference-purpose mixed audio data. The acoustic component for example, a time series of a power spectrum calculated from an audio signal by short-time Fourier transform (STFT). The acoustic component is given to the acoustic-feature estimating unit 139 and the speech restoring unit 145.

The acoustic-feature estimating unit 139 inputs the acoustic component from the acoustic-component calculating unit 138 to the feature estimation NN, which is a feature estimation model trained to estimate an acoustical feature of speech and noise.

For example, the acoustic-feature estimating unit 139 inputs the acoustic component received from the acoustic-component calculating unit 138 to the feature estimation NN stored in the feature-estimation-NN storage unit 132 and estimates an acoustic feature. The feature estimation NN is a neural network composed of multiple layers, and as to the propagation between layers, for example, a technique similar to long short-term memory or (LSTM) a technique combining one-dimensional convolution operations may be used where the number of layers is not limited. The acoustic feature is given to the correlation estimating unit 142 and the feature integrating unit 143.

The noise-component calculating unit 140 calculates a noise component from noise data that contains noise but does not contain target speech audio by using a predetermined function.

For example, the noise-component calculating unit 140 receives the inference-purpose noise data from the noise acquiring unit 137 and calculates a noise component from the noise represented by the inference-purpose noise data. The noise component is, for example, a time series of a power spectrum calculated from an audio signal by short-time Fourier transform (STFT). The noise component is given to the noise-feature estimating unit 141.

The noise-feature estimating unit 141 inputs the noise component from the noise-component calculating unit 140 to the noise estimation NN, which is a noise estimation model trained to estimate an acoustical feature of noise, to estimate a noise feature.

For example, the noise-feature estimating unit 141 inputs the noise component from the noise-component calculating unit 140 to the noise estimation NN stored in the noise-estimation-NN storage unit 133 and estimates the noise feature. Here, the noise estimation NN is a neural network composed of multiple layers, and as to the propagation between layers, for example, a technique similar to LSTM or a technique combining one-dimensional convolution operations may be used where the number of layers is not limited.

The correlation estimating unit 142 estimates a correlation between the acoustic feature and the noise feature by inputting the acoustic feature and the noise feature to the correlation estimation NN, which is a correlation estimation model trained to estimate a correlation between the acoustical feature of speech and noise and the acoustical feature of noise.

For example, the correlation estimating unit 142 inputs the acoustic feature estimated by the acoustic-feature estimating unit 139 and the noise feature estimated by the noise-feature estimating unit 141 to the correlation estimation NN stored in the correlation-estimation-NN storage unit 134 and estimates a correlation between the two features. The correlation is given to the feature integrating unit 143.

Here, the correlation estimation NN may be, for example, an attention NN as described in the following reference.

Reference: A. Vaswani et al., “Attention Is All You Need,” in Proc. NIPS, 2017.

The feature integrating unit 143 calculates an integrated feature by weighting the acoustic feature with the estimated correlation.

For example, the feature integrating unit 143 integrates the acoustic feature from the acoustic-feature estimating unit 139 and the correlation from the correlation estimating unit 142. Integration means transforming these two matrix representations into one matrix representation. For example, when the acoustic feature is expressed in a time-frequency representation of N×time and the correlation is expressed in a time-frequency representation of M×time, these may be linked on a frequency axis different from the time axis to form a time-frequency representation of (N+M)×time, or the number of dimensions on the frequency axis of the acoustic feature and the frequency axis of the correlation may be unified through some kind of dimensional transformation to obtain the element product of the two matrices.

The mask estimating unit 144 estimates a target speech mask by inputting the integrated feature to the speech enhancement NN, which is a speech enhancement model trained to estimate a mask for enhancing speech.

For example, the mask estimating unit 144 receives the integrated feature from the feature integrating unit 143 as input and estimates a mask by using the speech enhancement NN stored in the speech-enhancement-NN storage unit 135. The speech enhancement NN is a neural network composed of multiple layers, and as to the propagation between layers, for example, a technique similar to LSTM or a technique combining one-dimensional convolution operations may be used where the number of layers is not limited.

Here, the mask is a time-frequency representation of the same magnitude as the acoustic component, when the acoustic component is a time-frequency representation of N× time. The mask estimating unit 144 may estimate only a target speech mask that enhances the target speech audio in the mixed audio or may also estimate, for example, a noise mask that enhances noise in the mixed audio. The estimated target speech mask, which is a mask that enhances the target speech audio, is given to the speech restoring unit 145.

The speech restoring unit 145 restores speech audio with the target speech audio enhanced from the acoustic component and the target speech mask.

For example, the speech restoring unit 145 applies the target speech mask from the mask estimating unit 144 to the acoustic component from the acoustic-component calculating unit 138 and further restores an audio signal by using, for example, an inverse short-time Fourier transform (iSTFT).

Some or all of the noise-mixed-audio acquiring unit 136, the noise acquiring unit 137, the acoustic-component calculating unit 138, the acoustic-feature estimating unit 139, the noise-component calculating unit 140, the noise-feature estimating unit 141, the correlation estimating unit 142, the feature integrating unit 143, the mask estimating unit 144, and the speech restoring unit 145 described above can be implemented by, for example, the memory 10 and the processor 11 such as a CPU that executes programs stored in the memory 10, as illustrated in FIG. 3A. Such programs may be provided over a network or may be recorded and provided on a recording medium. That is, such programs may be provided, for example, as a program product.

Some or all of the noise-mixed-audio acquiring unit 136, the noise acquiring unit 137, the acoustic-component calculating unit 138, the acoustic-feature estimating unit 139, the noise-component calculating unit 140, the noise-feature estimating unit 141, the correlation estimating unit 142, the feature integrating unit 143, the mask estimating unit 144, and the speech restoring unit 145 can be implemented by, for example, a processing circuit 12, such as a single circuit, a composite circuit, a processor ran by a program, a parallel processor ran by a program, an ASIC, or an FPGA, as illustrated in FIG. 3B.

As described above, the noise-mixed-audio acquiring unit 136, the noise acquiring unit 137, the acoustic-component calculating unit 138, the acoustic-feature estimating unit 139, the noise-component calculating unit 140, the noise-feature estimating unit 141, the correlation estimating unit 142, the feature integrating unit 143, the mask estimating unit 144, and the speech restoring unit 145 can be implemented by processing circuitry.

The feature-estimation-NN storage unit 132, the noise-estimation-NN storage unit 133, the correlation-estimation-NN storage unit 134, and the speech-enhancement-NN storage unit 135 can be implemented by storage (not illustrated) such as an HDD, an SSD, or a non-volatile memory.

The communication unit 131 can be implemented by a communication interface, such as an NIC.

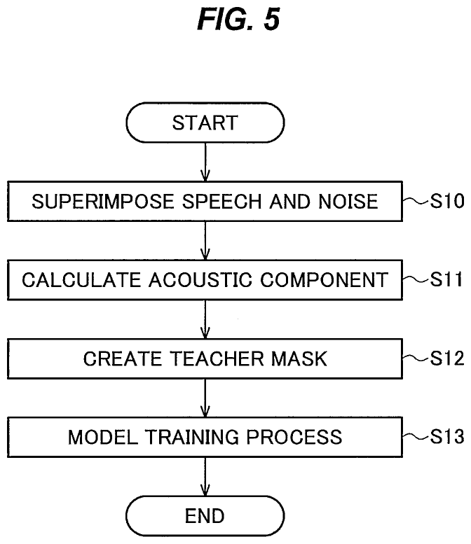

FIG. 5 is a flowchart illustrating the operation of the training device 110 according to the first embodiment.

First, the audio mixing unit 113 acquires training-purpose speech data from the speech-data storage unit 111 and training-purpose noise data from the noise-data storage unit and 112 generates mixed audio by superimposing the training-purpose target speech audio represented by the training-purpose speech data and noise from the noise data (step S10).

Next, the component calculating unit 114 calculates a target speech component and a mixed audio component from the target speech audio and the mixed audio, respectively, from the audio mixing unit 113 (step S11).

Next, the teacher-mask estimating unit 115 generates a teacher mask from the target speech component and the mixed audio component from the component calculating unit 114 (step S12).

Next, the model training unit 116 receives the mixed audio from the audio mixing unit 113, the training-purpose noise data from the noise-data storage unit 112, and the teacher mask from the teacher-mask estimating unit 115 and trains the NNs to generate a feature estimation NN, a noise estimation NN, a correlation estimation NN, and a speech enhancement NN (step S13). The feature estimation NN, the noise estimation NN, the correlation estimation NN, and the speech enhancement NN generated by training the NNs are stored in the model storage unit 117 and sent to the speech enhancement device 130.

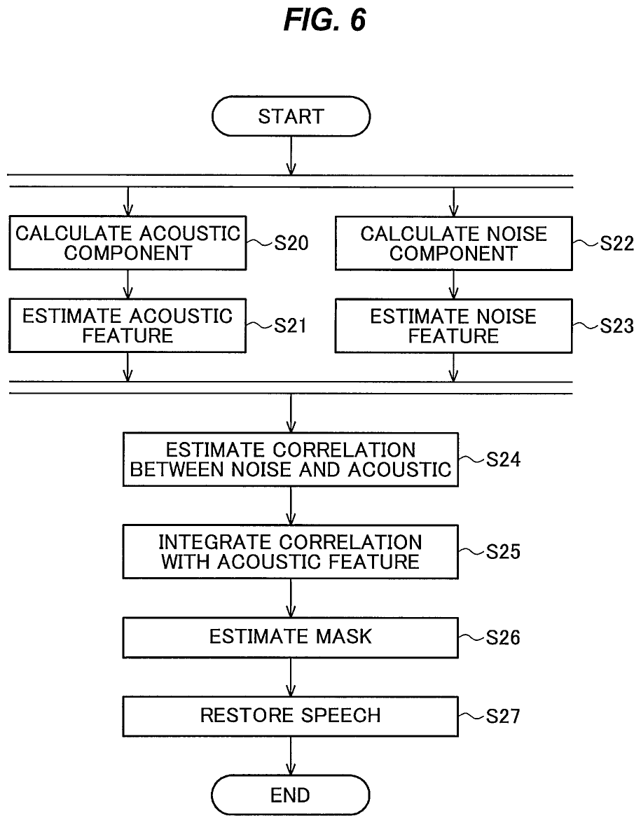

FIG. 6 is a flowchart illustrating the operation of the speech enhancement device 130 according to the first embodiment.

First, the acoustic-component calculating unit 138 receives inference-purpose mixed audio data from the noise-mixed-audio acquiring unit 136 and calculates an acoustic component from the mixed audio indicated by the inference-purpose mixed audio data (step S20).

Next, the acoustic-feature estimating unit 139 inputs the acoustic component received from the acoustic-component calculating unit 138 to the feature estimation NN stored in the feature-estimation-NN storage unit 132 and estimates an acoustic feature (step S21).

The noise-component calculating unit 140 receives inference-purpose noise data from the noise acquiring unit 137 and calculates a noise component from the inference-purpose noise data (step S22).

Next, the noise-feature estimating unit 141 inputs the noise component from the noise-component calculating unit 140 to the noise estimation NN stored in the noise-estimation-NN storage unit 133 and estimates a noise feature (step S23).

Next, the correlation estimating unit 142 inputs the acoustic feature estimated by the acoustic-feature estimating unit 139 and the noise feature estimated by the noise-feature estimating unit 141 to the correlation estimation NN stored in the correlation-estimation-NN storage unit 134 and estimates the correlation between the two features (step S24).

Next, the feature integrating unit 143 integrates the acoustic feature from the acoustic-feature estimating unit 139 and the correlation from the correlation estimating unit 142 (step S25). This generates an integrated feature.

The mask estimating unit 144 receives the integrated feature from the feature integrating unit 143 as an input and estimates a mask by using the speech enhancement NN stored in the speech-enhancement-NN storage unit 135 (step S26).

Next, the speech restoring unit 145 applies a target speech mask from the mask estimating unit 144 to the acoustic component from the acoustic-component calculating unit 138 and further restores an audio signal with the target speech audio enhanced, for example, by using an inverse short-time Fourier transform (iSTFT) (step S27).

As described above, according to the first embodiment, speech can be enhanced even in unknown noise not contained in the training data by extracting features from not only data on noise mixed audio containing target speech audio and noise but also noise not containing the target speech audio and assumed to be similar to the mixed noise, estimating a correlation of the features extracted from the data and noise, and inputting the correlation to a trained model.

In other words, according to the first embodiment, since a feature is extracted from noise, and a correlation between a feature extracted from the noise and a feature extracted from the noise superimposition audio is estimated by NNs, speech can be robustly enhanced even in unknown noise.

### Second Embodiment

In the second embodiment, speech segments are detected to distinguish between mixed audio and noise.

As illustrated in FIG. 1, a speech enhancement system 200 according to the second embodiment includes a training device 110 and a speech enhancement device 230.

The training device 110 of the speech enhancement system 200 according to the second embodiment is the same as the training device 110 of the speech enhancement system 100 according to the first embodiment.

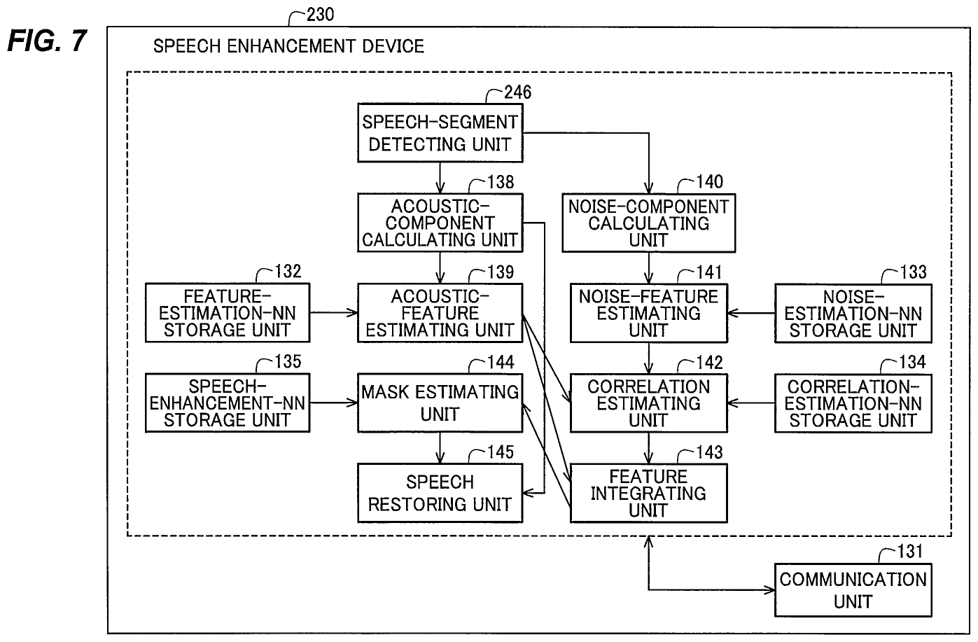

FIG. 7 is a block diagram schematically illustrating a configuration of the speech enhancement device 230 according to the second embodiment.

The speech enhancement device 230 includes a communication unit 131, a feature-estimation-NN storage unit 132, a noise-estimation-NN storage unit 133, a correlation-estimation-NN storage unit 134, a speech-enhancement-NN storage unit 135, an acoustic-component calculating unit 138, an acoustic-feature estimating unit 139, a noise-component calculating unit 140, a noise-feature estimating unit 141, a correlation estimating unit 142, a feature integrating unit 143, a mask estimating unit 144, a speech restoring unit 145, and a speech-segment detecting unit 246.

The communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the noise-feature estimating unit 141, the feature integrating unit 143, the mask estimating unit 144, and the speech restoring unit 145 of the speech enhancement device 230 according to the second embodiment are respectively the same as the communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the noise-feature estimating unit 141, the feature integrating unit 143, the mask estimating unit 144, and the speech restoring unit 145 of the speech enhancement device 130 according to the first embodiment

However, the acoustic-component calculating unit 138 uses speech segment data from the speech-segment detecting unit 246 unit as inference-purpose mixed audio data to calculate an acoustic component from the inference-purpose mixed audio data, and the noise-component calculating unit 140 uses non-speech segment data from the speech-segment detecting unit 246 as inference-purpose noise data to calculate a noise component from the inference-purpose noise data.

The speech-segment detecting unit 246 uses acoustic data including segments containing target speech audio and segments not containing target speech audio, to generate mixed audio data from data on the segments containing target speech audio and generate noise data from data on the segments not containing target speech audio.

For example, the speech-segment detecting unit 246 detects speech segments containing speech and non-speech segments not containing speech from the sound represented by acoustic data collected with a microphone (not illustrated) functioning as a sound collecting unit. The speech-segment detecting unit 246 then gives the speech segment data, which is the data on the speech segments in the acoustic data, to the acoustic-component calculating unit 138 and gives the non-speech segment data, which is the data on the non-speech segments, to the noise-component calculating unit 140.

Here, the speech segments may be detected by using a known technique such as the speech segment detection method disclosed in International Publication No. WO 2016/143125. A speech segment may be determined by using a threshold based on the power of the acoustic signal input to the microphone.

The speech-segment detecting unit 246 described above can be implemented by, for example, a memory 10 and a processor 11 such as a CPU that executes a program stored in the memory 10, as illustrated in FIG. 3A.

The speech-segment detecting unit 246 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 3B.

As described above, the speech-segment detecting unit 246 can be implemented by processing circuitry.

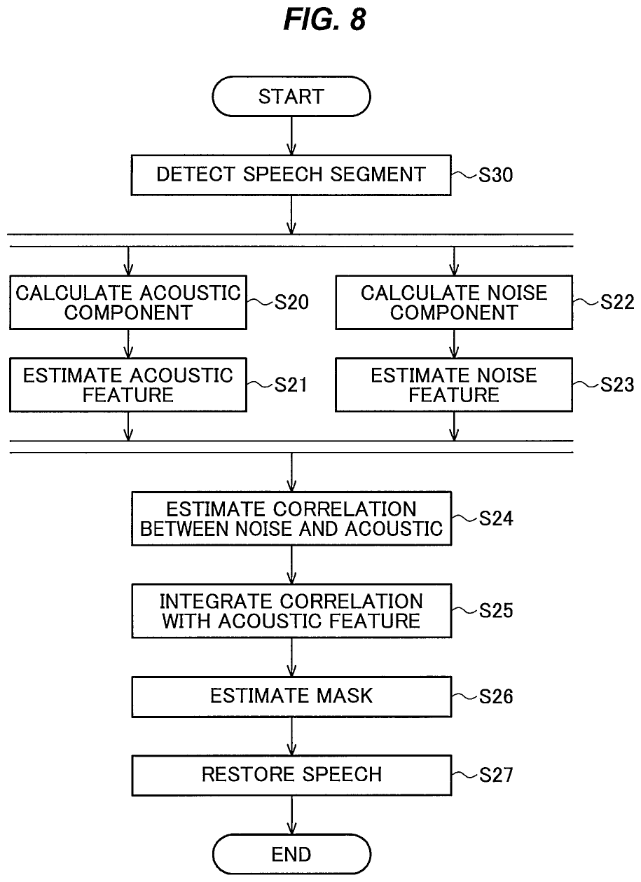

FIG. 8 is a flowchart illustrating the operation of the speech enhancement device 230 according to the second embodiment.

In FIG. 8, steps for processing that is the same as the processing in the flowchart illustrated in FIG. 6 are denoted by the same reference numerals as the corresponding steps in FIG. 6.

First, the speech-segment detecting unit 246 generates speech segment data and non-speech segment data from acoustic data collected with a microphone and gives the speech segment data to the acoustic-component calculating unit 138 and the non-speech segment data to the noise-component calculating unit 140 (step S30). The process then proceeds to steps S20 and S22.

The processing in steps S20 to S27 in FIG. 8 is the same as the processing in steps S20 to S27 in FIG. 6. However, the speech segment data is treated as inference-purpose mixed audio data, and the non-speech segment data is treated as inference-purpose noise data.

As described above, according to the second embodiment, speech segment data and non-speech segment data are generated from acoustic data collected with a microphone and can be treated as inference-purpose mixed audio data and inference-purpose noise data, respectively.

In other words, according to the second embodiment, detection of speech segments enables the detection of noise-only segments and other segments in mixed audio of noise and speech, and speech can be robustly enhanced even in unknown noise without manual addition of noise.

### Third Embodiment

In the third embodiment, inference-purpose mixed audio is divided into blocks to process the blocked inference-purpose mixed audio and noise can be restored.

As illustrated in FIG. 1, a speech enhancement system 300 according to the third embodiment includes a training device 310 and a speech enhancement device 330.

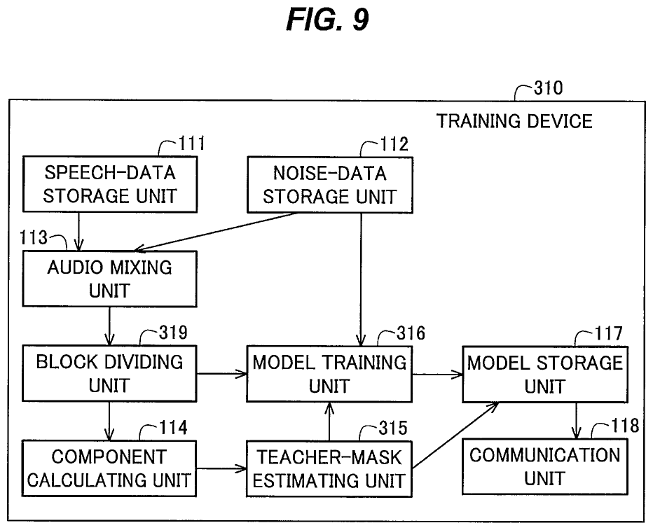

FIG. 9 is a block diagram schematically illustrating a configuration of the training device 310 according to the third embodiment.

The training device 310 includes a speech-data storage unit 111, a noise-data storage unit 112, an audio mixing unit 113, a component calculating unit 114, a teacher-mask estimating unit 315, a model training unit 316, a model storage unit 117, a communication unit 118, and a block dividing unit 319.

The speech-data storage unit 111, the noise-data storage unit 112, the audio mixing unit 113, the component calculating unit 114, the model training unit 116, the model storage unit 117, and the communication unit 118 of the training device 310 according to the third embodiment are respectively the same as the speech-data storage unit 111, the noise-data storage unit 112, the audio mixing unit 113, the component calculating unit 114, the model training unit 116, the model storage unit 117, and the communication unit 118 of the training device 110 according to the first embodiment.

However, the audio mixing unit 113 gives target speech audio and mixed audio to the block dividing unit 319.

The component calculating unit 114 calculates an acoustic component for each block from the block dividing unit 319.

The block dividing unit 319 divides the target speech audio and the mixed audio from the audio mixing unit 113 into blocks each having a fixed time length and gives the blocks to the component calculating unit 114 and the model training unit 116.

The teacher-mask estimating unit 315 performs the same processing as the teacher-mask estimating unit 115 of the first embodiment and also estimates a noise mask that enhances noise in the blocks from the block dividing unit 319 as a teacher mask and gives the estimated teacher mask to the model training unit 316.

The model training unit 316 receives the blocks from the block dividing unit 319, training-purpose noise data from the noise-data storage unit 112, and the teacher mask from the teacher-mask estimating unit 315, and trains a speech enhancement NN. In the third embodiment, the model training unit 316 trains the speech enhancement NN while restoring noise from the blocks by using the noise mask from the teacher-mask estimating unit 315.

The model training unit 316 receives the blocks from the block dividing unit 319, the training-purpose noise data from the noise-data storage unit 112, and the teacher mask from the teacher-mask estimating unit 315 and re-trains the speech enhancement NN. Here too, the model training unit 316 re-trains the speech enhancement NN while restoring noise from the blocks by using the noise mask from the teacher-mask estimating unit 315.

The block dividing unit 319 described above can also be implemented by, for example, a memory 10 and a processor 11 such as a CPU that executes a program stored in the memory 10, as illustrated in FIG. 3A.

The block dividing unit 319 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 3B.

As described above, the block dividing unit 319 can be implemented by processing circuitry.

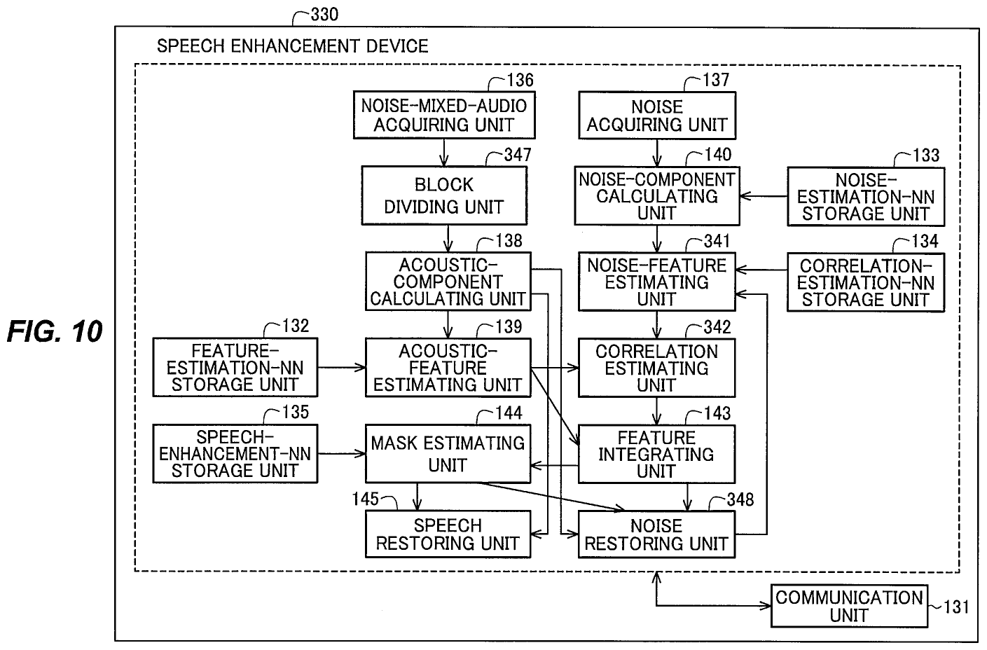

FIG. 10 is a block diagram schematically illustrating a configuration of the speech enhancement device 330 according to the third embodiment.

The speech enhancement device 330 includes a communication unit 131, a feature-estimation-NN storage unit 132, a noise-estimation-NN storage unit 133, a correlation-estimation-NN storage unit 134, a speech-enhancement-NN storage unit 135, an acoustic-component calculating unit 138, an acoustic-feature estimating unit 139, a noise-component calculating unit 140, a noise-feature estimating unit 341, a correlation estimating unit 342, a feature integrating unit 143, a mask estimating unit 144, a speech restoring unit 145, a block dividing unit 347, and a noise restoring unit 348.

The communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the feature integrating unit 143, the mask estimating unit 144, and the speech restoring unit 145 of the speech enhancement device 330 according to the third embodiment are respectively the same as the communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the feature integrating unit 143, the mask estimating unit 144, and the speech restoring unit 145 of the speech enhancement device 130 according to the first embodiment.

However, the acoustic-component calculating unit 138 calculates an acoustic component from each of the brocks into which inference-purpose mixed audio data divided by the block dividing unit 347.

The mask estimating unit 144 gives the estimated mask also to the noise restoring unit 348. Here, it is sufficient to provide a noise mask, which is a mask for enhancing noise; however, if the mask estimating unit 144 does not estimate a noise mask, the mask estimating unit 144 generates a mask that enhances noise on the basis of a target speech mask and gives the generated noise mask to the noise restoring unit 348. For example, when a teacher mask is expressed as a ratio of a power spectrum of target speech audio to a power spectrum of mixed audio, a noise mask can be obtained by subtracting, from one, each element of the mask that enhances the target speech audio in the mixed audio.

The block dividing unit 347 divides the mixed audio data into blocks.

For example, the block dividing unit 347 divides the inference-purpose mixed audio data from the noise-mixed-audio acquiring unit 136 into blocks each having a certain time length and gives the blocks to the acoustic-component calculating unit 138. The acoustic-component calculating unit 138 according to the third embodiment calculates an acoustic component for each of the blocks.

The blocks are preferably divided so as to include superimposition, for example, as described in the above-mentioned reference “Deep clustering-based single-channel speech separation and recent advances.”

The noise restoring unit 348 calculate a restored noise component by enhancing noise with the acoustic components and the noise mask.

For example, the noise restoring unit 348 applies the noise mask output by the mask estimating unit 144 to an acoustic component from the acoustic-component calculating unit 138 to calculate a restored noise component. The restored noise component is given to the noise-feature estimating unit 341.

In addition to executing the processing by the noise-feature estimating unit 141 according to the first embodiment, the noise-feature estimating unit 341 estimates a restored noise feature by inputting the restored noise components outputted by the noise restoring unit 348 to the noise estimation NN. The restored noise feature is combined with an already estimated noise feature in the time direction, and this is outputted to the correlation estimating unit 342 as a combined noise feature.

When the combined noise feature is generated, the correlation estimating unit 342 estimates a correlation from the acoustic feature and the combined noise feature.

For example, in addition to executing the processing by the correlation estimating unit 142 according to the first embodiment, the correlation estimating unit 342 inputs the acoustic feature estimated by the acoustic-feature estimating unit 139 and the combined noise feature estimated by the noise-feature estimating unit 341 to the correlation estimation NN stored in the correlation-estimation-NN storage unit 134, to estimate the correlation between the two features. The correlation is given to the feature integrating unit 143.

In the third embodiment, since the noise-feature estimating unit 341 generates a combined noise feature by combining, in the time direction, the restored noise feature with a noise feature estimated in the block immediately following the block for which a restored noise component is calculated, the correlation estimating unit 342 also estimates a correlation from the acoustic feature and the combined noise feature for the block immediately following the block for which the restored noise component is calculated.

Some or all of the block dividing unit 347 and the noise restoring unit 348 described above can be implemented by, for example, a memory 10 and a processor 11 such as a CPU that executes a program stored in the memory 10, as illustrated in FIG. 3A.

Some or all of the block dividing unit 347 and the noise restoring unit 348 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 3B.

As described above, some or all of the block dividing unit 347 and the noise restoring unit 348 can be implemented by processing circuitry.

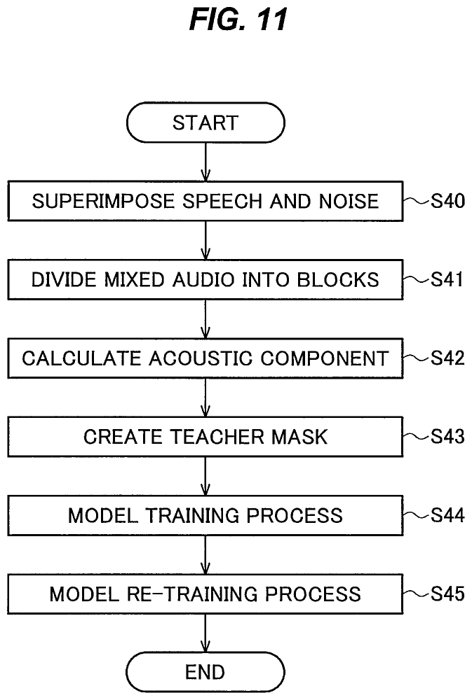

FIG. 11 is a flowchart illustrating the operation of the training device 310 according to the third embodiment.

First, the audio mixing unit 113 acquires training-purpose speech data from the speech-data storage unit 111 and training-purpose noise data from the noise-data storage unit 112 generates mixed audio by and superimposing the training-purpose target speech audio represented by the training-purpose speech data and noise represented by the training-purpose noise data (step S40).

Next, the block dividing unit 319 divides the target speech audio and the mixed audio from the audio mixing unit 113 into blocks (step S41).

Next, the component calculating unit 114 calculates a target speech component and a mixed audio component from the blocks of target speech audio and mixed audio, respectively, from the block dividing unit 319 (step S42).

Next, the teacher-mask estimating unit 115 generates, as teacher masks: a target speech mask for emphasizing target speech audio in the target speech component and the mixed audio component from the component calculating unit 114 and a noise mask for emphasizing noise (step S43).

Next, the model training unit 316 receives the mixed audio from the audio mixing unit 113, the training-purpose noise data from the noise-data storage unit 112, and the teacher masks from the teacher-mask estimating unit 115 and trains the NNs to generate a feature estimation NN, a noise estimation NN, a correlation estimation NN, and a speech enhancement NN (step S44). The feature estimation NN, the noise estimation NN, the correlation estimation NN, and the speech enhancement NN generated through training of the NNs are stored in the model storage unit 117.

The model training unit 316 receives the mixed audio from the audio mixing unit 113, the training-purpose noise data from the noise-data storage unit 112, and the teacher masks from the teacher-mask estimating unit 115, and re-trains the speech enhancement NN to generate a feature estimation NN, a noise estimation NN, a correlation estimation NN, and a speech enhancement NN (step S45). The feature estimation NN, the noise estimation NN, the correlation estimation NN, and the speech enhancement NN generated through re-training of the speech enhancement NN are stored in the model storage unit 117 and sent to the speech enhancement device 130.

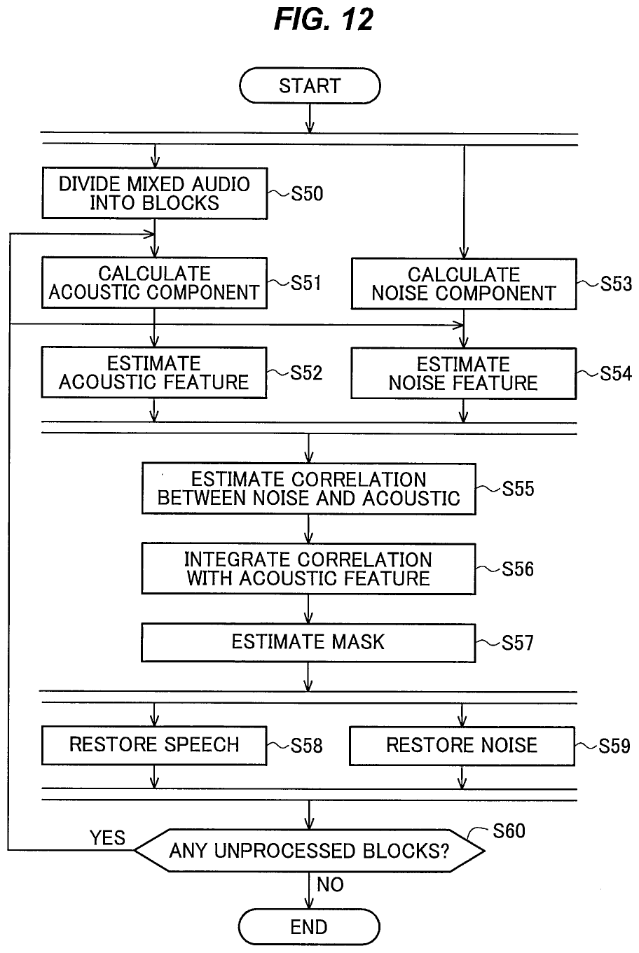

FIG. 12 is a flowchart illustrating the operation of the speech enhancement device 330 according to the third embodiment.

First, the block dividing unit 347 receives inference-purpose mixed audio data from the noise-mixed-audio acquiring unit 136 and divides the inference-purpose mixed audio data into blocks each having a certain time length (step S50). The block dividing unit 347 then gives the blocks one by one in chronological order to the acoustic-component calculating unit 138.

Next, the acoustic-component calculating unit 138 receives the blocks from the block dividing unit 347 and calculates acoustic components from the mixed audio indicated in the blocks (step S51).

Next, the acoustic-feature estimating unit 139 inputs the acoustic components received from the acoustic-component calculating unit 138 to the feature estimation NN stored in the feature-estimation-NN storage unit 132 and estimates an acoustic feature (step S52).

The noise-component calculating unit 140 receives the inference-purpose noise data from the noise acquiring unit 137 and calculates noise components from the inference-purpose noise data (step S53).

Next, the noise-feature estimating unit 341 inputs the noise components from the noise-component calculating unit 140 to the noise estimation NN stored in the noise-estimation-NN storage unit 133 and estimates a noise feature (step S54).

Next, the correlation estimating unit 342 inputs the acoustic feature estimated by the acoustic-feature estimating unit 139 and the noise feature estimated by the noise-feature estimating unit 141 to the correlation estimation NN stored in the correlation-estimation-NN storage unit 134 and estimates the correlation between the two features (step S55).

Next, the feature integrating unit 143 integrates the acoustic feature from the acoustic-feature estimating unit 139 and the correlation from the correlation estimating unit 342 (step S56).

The mask estimating unit 144 receives the integrated feature from the feature integrating unit 143 as an input and estimates a mask by using the speech enhancement NN stored in the speech-enhancement-NN storage unit 135 (step S57).

Next, the speech restoring unit 145 applies the target speech mask from the mask estimating unit 144 to the acoustic components from the acoustic-component calculating unit 138 and further restores an audio signal with the target speech audio enhanced, for example, by using an inverse short-time Fourier transform (iSTFT) (step S58).

The noise restoring unit 348 applies the noise mask outputted by the mask estimating unit 144 to the acoustic components from the acoustic-component calculating unit 138 to calculate restored noise components.

The block dividing unit 347 then determines whether or not there are any blocks remaining that have not been given to the acoustic-component calculating unit 138 (step S60). If such a block remains (Yes in step S60), the process returns to steps S51 and S54, and if such a block does not remain (No in step S60), the process ends.

When the process returns from step S60 to step S54, the noise-feature estimating unit 341 inputs the restored noise components restored by the noise restoring unit 348 to the noise estimation NN stored in the noise-estimation-NN storage unit 133 and estimates a restored noise feature.

Then, in step S55, the correlation estimating unit 342 inputs the acoustic feature estimated by the acoustic-feature estimating unit 139 and the restored noise feature estimated by the noise-feature estimating unit 141 to the correlation estimation NN stored in the correlation-estimation-NN storage unit 134 and estimates a correlation between the two features.

As described above, according to the third embodiment, by enhancing speech through block processing, it is possible to reduce processing delay in speech enhancement, and further, by using noise estimated from a block immediately preceding the block currently being enhanced, it is possible to improve robustness against unknown noise. In addition, during training, the model can be trained efficiently by first training the model by using noise extracted from an immediately preceding block using a true mask estimated by the teacher-mask estimating unit, and then training the model by using noise extracted with the mask estimated from an immediately preceding block, as in the case of inference.

### Fourth Embodiment

In the fourth embodiment, the likelihood of a restored noise component is calculated to determine whether or not to use the restored noise component.

As illustrated in FIG. 1, a speech enhancement system 400 according to the fourth embodiment includes a training device 310 and a speech enhancement device 430.

The training device 310 of the speech enhancement system 400 according to the fourth embodiment is the same as the training device 310 of the speech enhancement system 300 according to the third embodiment.

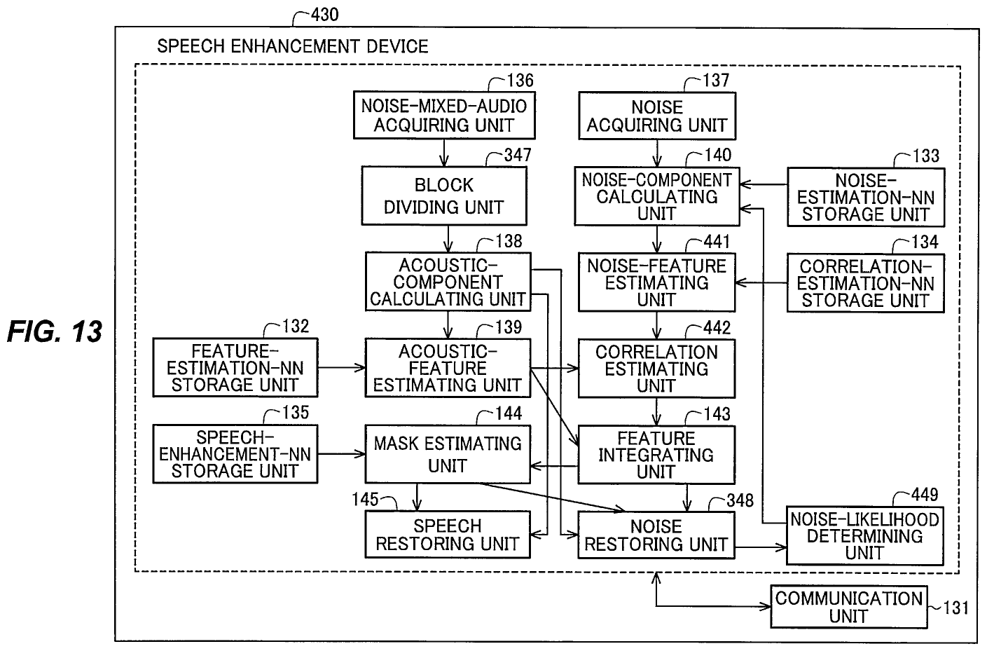

FIG. 13 is a block diagram schematically illustrating a configuration of the speech enhancement device 430 according to the fourth embodiment.

The speech enhancement device 430 includes a communication unit 131, a feature-estimation-NN storage unit 132, 10 noise-estimation-NN storage unit 133, a correlation-estimation-NN storage unit 134, a speech-enhancement-NN storage unit 135, an acoustic-component calculating unit 138, an acoustic-feature estimating unit 139, a noise-component calculating unit 140, a noise-feature estimating unit 441, a correlation estimating unit 142, a feature integrating unit 143, a mask estimating unit 144, a speech restoring unit 145, a block dividing unit 347, a noise restoring unit 348, and a noise-likelihood determining unit 449.

The communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the feature integrating unit 143, the mask estimating unit 144, and the speech restoring unit 145 of the speech enhancement device 430 according to the fourth embodiment are respectively the same as the communication unit 131, the feature-estimation-NN storage unit 132, the noise-estimation-NN storage unit 133, the correlation-estimation-NN storage unit 134, the speech-enhancement-NN storage unit 135, the acoustic-component calculating unit 138, the acoustic-feature estimating unit 139, the noise-component calculating unit 140, the feature integrating unit 143, the mask estimating unit 144, and the speech restoring unit 145 of the speech enhancement device 130 according to the first embodiment.

However, the acoustic-component calculating unit 138 calculates an acoustic component from each of the brocks into which inference-purpose mixed audio data divided by the block dividing unit 347.

The mask estimating unit 144 gives the estimated mask also to the noise restoring unit 348. Here, it is sufficient if a noise mask is provided; however, if the mask estimating unit 144 does not estimate a noise mask, the mask estimating unit 144 generates a mask that enhances noise on the basis of a target speech mask and gives the generated noise mask to the noise restoring unit 348. For example, when a teacher mask is expressed as a ratio of a power spectrum of target speech audio to a power spectrum of mixed audio, a noise mask can be obtained by subtracting, from one, each element of the mask that enhances the target speech audio in the mixed audio.

The block dividing unit 347 and the noise restoring unit 348 of the speech enhancement device 430 according to the fourth embodiment are respectively the same as to the block dividing unit 347 and the noise restoring unit 348 of the speech enhancement device 330 according to the third embodiment.

However, the noise restoring unit 348 according to the fourth embodiment gives restored noise components to the noise-likelihood determining unit 449.

The noise-likelihood determining unit 449 calculates noise likelihood, which is the likelihood of a restored noise component, and determines whether or not the noise likelihood is equal to or greater than a predetermined threshold.

For example, the noise-likelihood determining unit 449 receives the restored noise components from the noise restoring unit 348 and calculates their noise likelihood. The noise-likelihood determining unit 449 then gives the restored noise components corresponding to blocks having a noise likelihood equal to or greater than the threshold to the noise-feature estimating unit 441.

Here, when a restored noise component is a time-frequency representation of N× time, the noise likelihood is calculated for each block corresponding to a time frame. The noise likelihood can be calculated by using an NN, as described in, for example, NPL 1. The threshold may be, for example, experimentally determined.

For a block immediately following the block corresponding to the restored noise component received from the noise-likelihood determining unit 449, the noise-feature estimating unit 441 inputs the restored noise component outputted by the noise-likelihood determining unit 449 to the noise estimation NN to estimate a restored noise feature and calculates a combined noise feature by combining the restored noise feature with the noise feature estimated from the noise component received from the noise-component calculating unit 140 in the time direction.

In contrast, for a block immediately following a block for which no restored noise component has been received from the noise-likelihood determining unit 449, the noise-feature estimating unit 441 estimates a noise feature from the noise component received from the noise-component calculating unit 140.

The noise-feature estimating unit 441 then gives the combined noise feature to the correlation estimating unit 342 for the block immediately following the block corresponding to the restored noise component received from the noise-likelihood determining unit 449 and gives the noise features for the other blocks to the correlation estimating unit 342.

In other words, the noise-feature estimating unit 441 generates a combined noise feature when the noise likelihood is equal to or greater than the threshold.

For a block for which the noise-feature estimating unit 441 has received a noise feature, the correlation estimating unit 442 inputs the acoustic feature estimated by the acoustic-feature estimating unit 139 and the noise feature estimated by the noise-feature estimating unit 341 to the correlation estimation NN stored in the correlation-estimation-NN storage unit 134, and estimates a correlation between the two features.

On the other hand, for a block for which the noise-feature estimating unit 441 has received a combined noise feature, the correlation estimating unit 442 inputs the acoustic feature estimated by the acoustic-feature estimating unit 139 and the combined noise feature estimated by the noise-feature estimating unit 341 to the correlation estimation NN stored in the correlation-estimation-NN storage unit 134, and estimates a correlation between the two features. The correlation is given to the feature integrating unit 143.

The noise-likelihood determining unit 449 described above can also be implemented by, for example, a memory 10 and a processor 11 such as a CPU that executes a program stored in the memory 10, as illustrated in FIG. 3A.

The noise-likelihood determining unit 449 can also be implemented by, for example, a single circuit, a composite circuit, a processor operated by a program, a parallel processor operated by a program, a processing circuit 12 such as an application specific integrated circuit (ASIC) or a field programmable gate array (FPGA), as illustrated in FIG. 3B.

As described above, the noise-likelihood determining unit 449 can be implemented by processing circuitry.

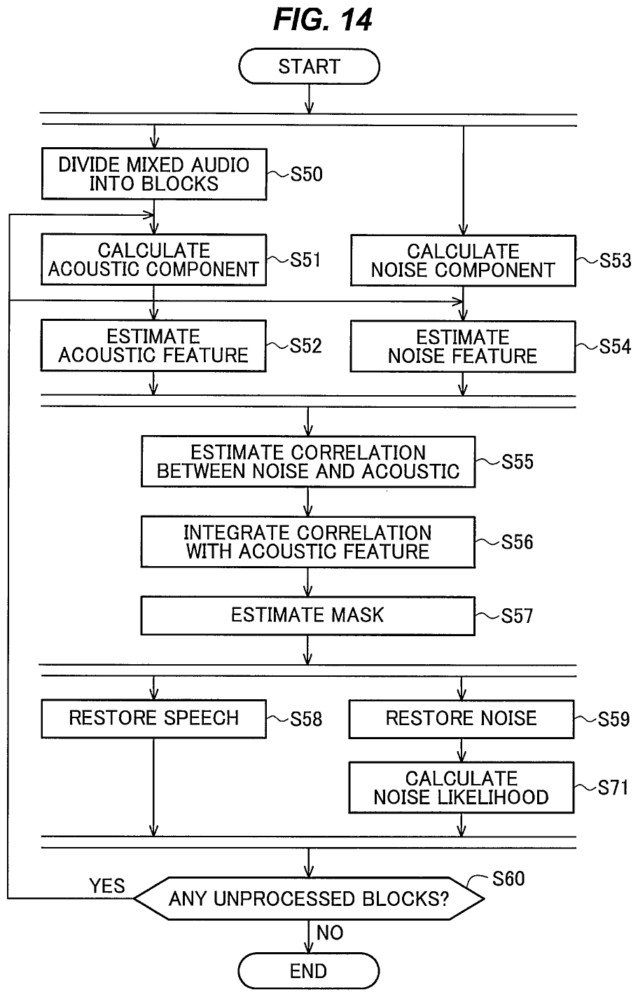

FIG. 14 is a flowchart illustrating the operation of the speech enhancement device 430 according to the fourth embodiment.

In FIG. 14, steps for process that is the same as the process in the flowchart illustrated in FIG. 12 are denoted by the same reference numerals as the corresponding steps in FIG. 12.

The processing of steps S50 to S53 in FIG. 14 is the same as the processing of steps S50 to S53 in FIG. 12. However, in FIG. 14, after the processing of step S53, the process proceeds to step S70.

In step S70, the noise-feature estimating unit 441 estimates a noise feature from the noise component received from the noise-component calculating unit 140. The process then proceeds to step S55.

The processing of steps S55 to S59 in FIG. 14 is the same as the processing of steps S55 to S59 in FIG. 12. However, in FIG. 14, after the processing of step S59, the process proceeds to step S71.

In step S71, the noise-likelihood determining unit 449 receives a restored noise component from the noise restoring unit 348 and calculates the noise likelihood. If the calculated noise likelihood is equal to or greater than the threshold, the noise-likelihood determining unit 449 gives the restored noise component to the noise-feature estimating unit 441. The process then proceeds to step S60.

In step S60, the block dividing unit 347 determines whether or not there are any blocks remaining that have not been given to the acoustic-component calculating unit 138. If such a block remains (Yes in step S60), the process returns to steps S51 and S70, and if such a block does not remain (No in step S60), the process ends.

When the process returns from step S60 to step S70, and the noise-feature estimating unit 441 receives a restored noise component from the noise-likelihood determining unit 449, the noise-feature estimating unit 441 calculates a combined noise feature by inputting the restored noise component restored by the noise restoring unit 348 to the noise estimation NN stored in the noise-estimation-NN storage unit 133, estimating the restored noise feature, and combining the restored noise feature with the noise feature estimated from the noise component received from the noise-component calculating unit 140 in the time direction.

In this case, in step S55, the correlation estimating unit 342 inputs the acoustic feature estimated by the acoustic-feature estimating unit 139 and the restored noise feature estimated by the noise-feature estimating unit 141 to the correlation estimation NN stored in the correlation-estimation-NN storage unit 134 and estimates a correlation between the two features.

As described above, according to the fourth embodiment, by using only a portion of the noise estimated from an immediately preceding block that has a high noise likelihood, it is possible to prevent learning noise that includes an estimation error.

What is claimed is:

1. An information processing device comprising: processing circuitry
to calculate an acoustic component from mixed audio data by using a predetermined function, the mixed audio data including target speech audio and mixed noise, the target speech audio being a target to be enhanced, the mixed noise being noise to be mixed with the target speech audio, the acoustic component being a component of the target speech audio and the mixed noise;
to estimate an acoustic feature by inputting the acoustic component to a feature estimation model trained to estimate an acoustical feature of speech and noise;
to calculate a noise component from noise data by using the predetermined function, the noise component being a component of noise, the noise data not including the target speech audio but including noise;
to estimate a noise feature by inputting the noise component to a noise estimation model trained to estimate an acoustical feature of the noise;
to estimate a correlation the acoustic feature and the noise feature by inputting the acoustic feature and the noise feature to a correlation estimation model trained to estimate a correlation between the acoustical feature of speech and noise, and the acoustical feature of noise;
to calculate an integrated feature by weighting the acoustic feature with the estimated correlation;
to estimate a target speech mask by inputting the integrated feature to a speech enhancement model trained to estimate a mask for enhancing speech; and
to restore speech audio in which the target speech audio is enhanced from the acoustic component and the target speech mask.

2. The information processing device according to claim 1, further comprising:
an interface to accept input of data; wherein, the processing circuitry acquires the mixed audio data via the interface, and acquires the noise data via the interface.

3. The information processing device according to claim 1, further comprising:
an interface to accept input of data; wherein, the processing circuitry acquires, via the interface, acoustic data having a segment including the target speech audio and a segment not including the target speech audio, generates the mixed audio data from data on the segment including the target speech audio in the acoustic data, and generates the noise data from data on the segment not including the target speech audio in the acoustic data.

4. The information processing device according to claim 1, wherein the processing circuitry divides the mixed audio data into a plurality of blocks, and calculates the acoustic component for the blocks.

5. The information processing device according to claim 2, wherein the processing circuitry divides the mixed audio data into a plurality of blocks, and calculates the acoustic component for the blocks.

6. The information processing device according to claim 3, wherein the processing circuitry divides the mixed audio data into a plurality of blocks, and calculates the acoustic component for the blocks.

7. The information processing device according to claim 4, wherein,
the processing circuitry further estimates a noise mask for enhancing noise, calculates a restored noise component by emphasizing noise with the acoustic component and the noise mask, estimates a restored noise feature by inputting the restored noise component to the noise estimation model, and generates a combined noise feature by combining the restored noise feature with the noise feature in a time direction, and
when the combined noise feature is generated, the processing circuitry estimates the correlation from the acoustic feature and the combined noise feature.

8. The information processing device according to claim 5, wherein,
the processing circuitry further estimates a noise mask for enhancing noise, calculates a restored noise component by emphasizing noise with the acoustic component and the noise mask, estimates a restored noise feature by inputting the restored noise component to the noise estimation model, and generates a combined noise feature by combining the restored noise feature with the noise feature in a time direction, and
when the combined noise feature is generated, the processing circuitry estimates the correlation from the acoustic feature and the combined noise feature.

9. The information processing device according to claim 6, wherein,
the processing circuitry further estimates a noise mask for enhancing noise, calculates a restored noise component by emphasizing noise with the acoustic component and the noise mask, estimates a restored noise feature by inputting the restored noise component to the noise estimation model, and generates a combined noise feature by combining the restored noise feature with the noise feature in a time direction, and
when the combined noise feature is generated, the processing circuitry estimates the correlation from the acoustic feature and the combined noise feature.

10. The information processing device according to claim 7, wherein the processing circuitry generates a combined noise feature by combining, in a time direction, the restored noise feature with the noise feature estimated for a block immediately following the block for which the restored noise component has been calculated.

11. The information processing device according to claim 8, wherein the processing circuitry generates a combined noise feature by combining, in a time direction, the restored noise feature with the noise feature estimated for a block immediately following the block for which the restored noise component has been calculated.

12. The information processing device according to claim 9, wherein the processing circuitry generates a combined noise feature by combining, in a time direction, the restored noise feature with the noise feature estimated for a block immediately following the block for which the restored noise component has been calculated.

13. The information processing device according to claim 7, wherein the processing circuitry calculates a noise likelihood, determines whether or not the noise likelihood is equal to or greater than a predetermined threshold, and generates the combined noise feature when the noise likelihood is equal to or greater than the threshold, the noise likelihood being a likelihood of the restored noise component.

14. The information processing device according to claim 8, wherein the processing circuitry calculates a noise likelihood, determines whether or not the noise likelihood is equal to or greater than a predetermined threshold, and generates the combined noise feature when the noise likelihood is equal to or greater than the threshold, the noise likelihood being a likelihood of the restored noise component.

15. The information processing device according to claim 9, wherein the processing circuitry calculates a noise likelihood, determines whether or not the noise likelihood is equal to or greater than a predetermined threshold, and generates the combined noise feature when the noise likelihood is equal to or greater than the threshold, the noise likelihood being a likelihood of the restored noise component.

16. A non-transitory computer-readable storage medium storing a program causing a computer to execute processing comprising:
calculating an acoustic component from mixed audio data by using a predetermined function, the mixed audio data including target speech audio and mixed noise, the target speech audio being a target to be enhanced, the mixed noise being noise to be mixed with the target speech audio, the acoustic component being a component of the target speech audio and the mixed noise;
estimating an acoustic feature by inputting the acoustic component to a feature estimation model trained to estimate an acoustical feature of speech and noise;
calculating a noise component from noise data by using the predetermined function, the noise component being a component of noise, the noise data not including the target speech audio and including noise;
estimating a noise feature by inputting the noise component to a noise estimation model trained to estimate an acoustical feature of the noise;
estimating a correlation between the acoustic feature and the noise feature by inputting the acoustic feature and the noise feature to a correlation estimation model trained to estimate a correlation between the acoustical feature of speech and noise, and the acoustical feature of noise;
calculating an integrated feature by weighting the acoustic feature with the estimated correlation;
estimating a target speech mask by inputting the integrated feature to a speech enhancement model trained to estimate a mask for enhancing speech; and
restoring speech audio in which the target speech audio is enhanced from the acoustic component and the target speech mask.

17. An information processing method comprising:
calculating an acoustic component from mixed audio data by using a predetermined function, the mixed audio data including target speech audio and mixed noise, the target speech audio being a target to be enhanced, the mixed noise being noise to be mixed with the target speech audio, the acoustic component being a component of the target speech audio and the mixed noise;
estimating an acoustic feature by inputting the acoustic component to a feature estimation model trained to estimate an acoustical feature of speech and noise;
calculating a noise component from noise data by using the predetermined function, the noise component being a component of noise, the noise data not including the target speech audio and including noise;
estimating a noise feature by inputting the noise component to a noise estimation model trained to estimate an acoustical feature of the noise;
estimating a correlation between the acoustic feature and the noise feature by inputting the acoustic feature and the noise feature to a correlation estimation model trained to estimate a correlation between the acoustical feature of speech and noise, and the acoustical feature of noise;
calculating an integrated feature by weighting the acoustic feature with the estimated correlation;
estimating a target speech mask by inputting the integrated feature to a speech enhancement model trained to estimate a mask for enhancing speech; and
restoring speech audio in which the target speech audio is enhanced from the acoustic component and the target speech mask.
